(19) United States
(12) Patent Application Publication
(10) Pub. No.: US 2004/0000088 A1
(43) Pub. Date: Jan. 1, 2004

(54) Cleaner-burning liquid candle fuel and candle made therefrom

(76) Inventor: John N. Wesley, Edison, NJ (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/186,594

(22) Filed: Jul. 1, 2002

(51) Int. Cl. C11C 5/00

(52) U.S. Cl. 44/275

(57) ABSTRACT

A cleaner-burning liquid candle fuel including at least about 65 wt. % of a hydrocarbon fuel selected from the group consisting of C₁₂-C₂₂ alkanes and mixtures thereof, about 1 wt. % to about 25 wt. % isopropanol, and about 0.5 wt. % to about 10 wt. % methanol is disclosed. Also disclosed is a liquid candle that incorporates the candle fuel, which includes a combination of fuel, vessel, and wick.

### BACKGROUND OF THE INVENTION

1. Field of the Invention

The invention generally relates to liquid fuels and, more specifically, to cleaner-burning liquid candle fuels and to candles made therefrom.

2. Brief Description of Related Technology

Lamps for liquid fuel such as paraffin and other oil fractions have been known for some considerable time, and are generally referred to as oil lamps. Such lamps typically include a fuel container and a burner with some means to draw the fuel from the reservoir, typically in the form of a cotton wick. The lamp can also include a frame and a shade for the flame in the burner. Whereas in former times they represented an important source of lighting, oil lamps are now used widely in the industrialized countries as decorative lighting.

A type of lamp for liquid fuel, commonly referred to as a liquid candle, is used professional applications, for example in restaurants as table lamps for decorative lighting. Such liquid candle table lamps have been devised which utilize a disposable liquid fuel cell. The cell typically includes a straight walled cylindrical shaped container that is closed and sealed by a lid. A burner is mounted on or formed by the lid with a wick adapted to draw fuel from the container to a burning zone. In assembly, the fuel cell is inserted into a receiving opening formed in the base of a lamp and a chimney can be seated upon the base over the fuel cell. The chimney typically includes a dependent cylindrical skirt that is slipped downwardly into the opening around the container. Such liquid candles typically also include a frame and a decorative shade such as a glass globe or decorative fabric shade for the flame in the burner.

Liquid paraffin (also called liquid wax), other oil fractions (e.g., mineral oil) and vegetable oils have been used as liquid candle fuels. While liquid candle fuels such as pure liquid paraffin are touted as smokeless and odorless, the reality is that some amount of soot is generated when such liquid candle fuels are burned. The soot contributes to a reduction in air quality and leaves deposits on surfaces. Soot deposits can discolor the walls and ceilings of a room and can accumulate on the shade used on decorative table lamps. In the case of glass globes, the glass must be washed to remove the deposits. In the case of fabric shades, the shades must frequently be discarded. Thus, there is a constant need for a cleaner-burning liquid fuel such as the type that can be used in liquid candles.

### SUMMARY OF THE INVENTION

One aspect of the invention is a cleaner-burning liquid candle fuel including or consisting essentially of at least about 65 wt. % of a hydrocarbon fuel selected from the group consisting of C₁₂-C₂₂ alkanes and mixtures thereof, about 1 wt. % to about 25 wt. % isopropanol, about 0.5 wt. % to about 10 wt. % methanol, and, optionally, about 0.5 wt % to about 50 wt. % soybean oil.

Another aspect of the invention is a liquid candle that incorporates the candle fuel, which includes a combination of fuel, vessel, and wick.

Further aspects and advantages of the invention may become apparent to those skilled in the art from a review of the following detailed description, taken in conjunction with the appended claims. While the invention is susceptible of embodiments in various forms, described hereinafter are specific embodiments of the invention with the understanding that the disclosure is illustrative, and is not intended to limit the invention to the specific embodiments described herein.

### BRIEF DESCRIPTION OF THE DRAWINGS

FIG. 1 is a partial cut-away drawing of a fuel/vessel/wick combination according to the invention.

FIG. 2 is a graph depicting flame heights of a fuel according to the invention and a prior art fuel over time.

FIG. 3 is a graph depicting flame heights of a fuel according to the invention and a prior art fuel over time.

FIG. 4a is a photo of a tile upon which soot was collected from the burning of a liquid paraffins/isopropanol/methanol fuel according to the invention.

FIG. 4b is a photo of a tile upon which soot was collected from the burning of a liquid paraffins fuel of the prior art.

FIG. 5 is a photo of a tile upon which soot was collected from the burning of a liquid paraffins/isopropanol/methanol/soy bean oil fuel according to the invention.

### DETAILED DESCRIPTION OF THE INVENTION

The invention is directed to a liquid fuel and, more specifically, to a cleaner-burning liquid candle fuel and to candles made therefrom. The term liquid candle as herein used refers to a heating or lighting device wherein liquid fuel is wicked from a fuel reservoir into a burning region via capillary action where the fuel is vaporized and then ignited to produce a flame about an exposed portion of the wick.

Generally, a fuel according to the invention can include or consist essentially of at least about 65 wt. % of a hydrocarbon fuel selected from the group consisting of C₁₂-C₂₂ alkanes and mixtures thereof, about 1 wt. % to about 25 wt. % isopropanol, and about 0.5 wt. % to about 10 wt. % methanol. Preferably, the hydrocarbon fuel is selected from C₁₄-C₁₈ alkanes, more preferably C₁₄-C₁₆ alkanes and mixtures thereof, more preferably normal alkanes (e.g., wherein at least about 50 wt. % of the alkanes are normal alkanes). A particularly preferred methanol-rich variation of the invention will include greater than 2 wt. % methanol. Optionally, a portion of the fuel can be a vegetable oil, preferably soybean oil, for example about 0.5 wt. % to about 50 wt. %, preferably about 0.5 wt. % to about 10 wt. %. Additives that contribute to the production of soot, such as low grade fragrances and colorants, should be avoided.

Thus, one type of fuel according to the invention includes about 40 wt. % to about 60 wt. % of a C₁₄ alkane, about 10 wt. % to about 35 wt. % of a C₁₅ alkane, about 1 wt. % to about 20 wt. % of a C₁₆ alkane, about 1 wt. % to about 15 wt. % isopropanol, and about 0.5 wt. % to about 2 wt. % methanol. This type of fuel can be made by adding the desired amount of methanol to a selected amount of isopropanol, and adding the alcohol mixture to NORPAR-15 paraffins, available from the Exxon Company of Houston, Tex. Soybean oil, when used, can be blended into the mixture at any point.

For safety considerations, a fuel according to the invention will be combustible but not flammable. The U.S. Occupational Health and Safety Administration (OSHA) defines a combustible liquid as “any liquid having a flash point at or above 100° F. (37.8° C.), but below 200° F. (93.3° C.), except any mixture having components with flashpoints of 200° F. (93.3° C.), or higher, the total volume of which make up 99 percent or more of the total volume of the mixture.” Similarly, a flammable liquid is defined as “any liquid having a flash point below 100° F. (37.8° C.), except any mixture having components with flash points of 100° F. (37.8° C.) or higher, the total of which make up 99 percent or more of the total volume of the mixture.” As more of the alcohol components are added, the flash point of the fuel is lowered, yet as more of the alcohol components are added, the fuel bums cleaner. Also, the alcohol components are generally more expensive than the alkane portion of the fuel. Thus, to provide a safe, inexpensive fuel, preferably the alcohol components are used in the lowest amount sufficient to provide an appreciable reduction in soot generation.

In one embodiment of the invention, the liquid candle fuel includes of at least about 30 wt. % of a C₁₅ alkane, about 1 wt. % to about 25 wt. % isopropanol and about 0.5 wt. % to about 10 wt. % methanol. Preferably, at least about 50 wt. % of the C₁₅ alkane is a normal alkane. This embodiment can, and preferably does, further include a C₁₄ alkane and a C₁₆ alkane. Thus, one particularly preferred fuel according to this embodiment includes about 40 wt. % to about 60 wt. % of a C₁₅ alkane, about 10 wt. % to about 35 wt. % of a C₁₄ alkane, and about 1 wt. % to about 20 wt. % of a C₁₆ alkane.

In another fuel according to the invention, the liquid candle fuel includes at least about 50 wt. % of at least two hydrocarbon fuels selected from the group consisting of C₁₄-C₁₆ alkanes, and mixtures thereof, about 1 wt. % to about 25 wt. % isopropanol, and about 0.5 wt. % to about 10 wt. % methanol.

In yet another fuel according to the invention, the liquid candle fuel can include or consist essentially of at least about 65 wt. % of a hydrocarbon fuel selected from the group consisting of C₁₂-C₂₂ alkanes and mixtures thereof, about 1 wt. % to about 25 wt. % isopropanol, and about 0.5 wt. % to about 10 wt. % methanol, wherein the fuel produces less than about 1.14% soot when burned, preferably less than about 0.8% soot, based on the weight of the fuel. Preferably, the fuel includes a mixture of C₁₄-C₁₆ alkanes.

In any of the embodiments described above, the preferred amount of isopropanol is about 15 wt. % or less and more preferably in a range of about 1 wt. % to about 5 wt. %. Furthermore, normal alkanes are preferred, for example such that at least about 50 wt. % of the alkanes are normal alkanes. When burned, a fuel according to the invention preferably produces the fuel produces less than about 1.2% soot, more preferably less than about 1% soot, even more preferably less than about 0.75 wt. % soot, based on the weight of the fuel.

In one particularly preferred embodiment of the invention, the liquid candle fuel consists essentially of at least about 74.5 wt. % of a hydrocarbon fuel selected from the group consisting of C₁₂-C₂₂ alkanes and mixtures thereof, about 1 wt. % to about 25 wt. % isopropanol, and about 0.5 wt. % to about 10 wt. % methanol.

To make a fuel according to the invention, one or more alkanes is blended with the isopropanol and methanol to form a single-phase mixture. In cases when the methanol is insoluble in the alkane portion of the mixture (such as in the examples below) it has been found that the methanol can be pre-blended into the isopropyl alcohol and then the mixture of alcohols can be blended with the alkane portion of the mixture to form a single-phase mixture.

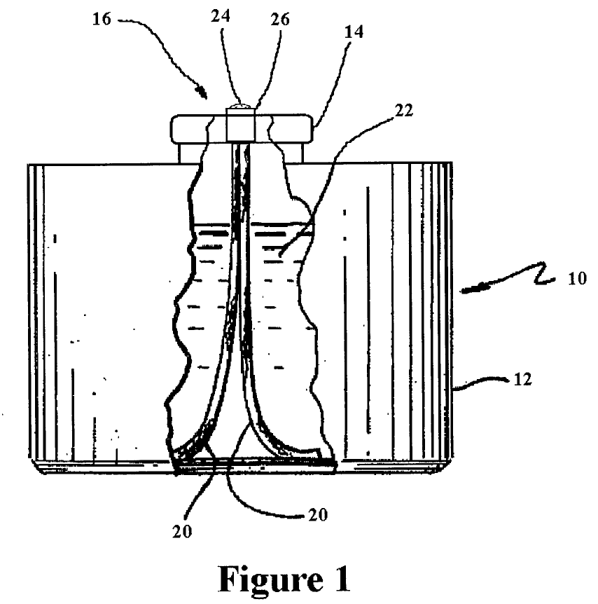

Another aspect of the invention is a combination of fuel/vessel/wick (liquid candle) that incorporates a liquid candle fuel according to the invention. Such a combination is depicted in FIG. 1, wherein a vessel 10 includes a cylindrical reservoir 12 and a cap 14 sealing the reservoir and providing a burning zone 16. A wick 20 is disposed in the vessel, partially immersed in fuel 22, and exposed at its tip 24 to the atmosphere through a wick holder 26 in the cap 14 at the top of the vessel 10 for drawing fuel 22 via capillary action to the burning zone 16. The vessel can be constructed of any material suitable for holding a liquid candle fuel according to the invention, and can be sealed or refillable. Preferably, the top of the vessel includes a burning zone constructed of metal or some other heat-resistant material. The wick can be constructed of any material capable of drawing a liquid candle fuel according to the invention from a reservoir in the vessel via capillary action, for example cotton, fiberglass, or the like.

### EXAMPLES

The following examples are provided to illustrate the invention but are not intended to limit the scope of the invention.

### Example 1

### Liquid Paraffins/Isopropanol/Methanol Blend

A blend of 98 wt. % NORPAR-15 brand liquid paraffins, 1.5 wt. % isopropanol, and 0.5 wt. % methanol was prepared by blending the alcohols together and then adding the mixture of alcohols to the liquid paraffins. The composition of the liquid paraffins is reported by the manufacturer as 99% normal paraffins (29-33 mass % C₁₄, 42-54 mass % C₁₅, 15-17 mass % C₁₆ mass %, 2-7 mass % C₁₇, and less than 1 mass % C₁₈), 1.0 mass % isoparaffins and cycloparaffins, and 0.01 mass % trace compounds (5 parts per million (ppm) sulfur, 7 ppm carbonyls, 3 ppm chlorides, and 1 ppm nitrogen). The densities of the components are: paraffins 0.77 g/ml, isopropanol 0.80 g/ml, and methanol 0.81 g/ml. Thus, the liquid candle fuel included 98.08% paraffins by volume, 1.44% isopropanol by volume, and 0.48% methanol by volume.

Combinations of fuel/reservoir/wick (liquid candles) were constructed and burned to test various features of the fuels. The fuel according to this example was loaded into a vessel including a plastic reservoir (cylindrical portion about 6 cm in diameter by about 5.5 in height, stepping to an overall height of about 7 cm) with an aluminum cap sealing the reservoir (about 3 cm in diameter) and providing a burning zone, and a cotton wick (about 2 mm in diameter) disposed in the vessel, partially immersed in the fuel, and exposed to the atmosphere through the cap at the top of the vessel for drawing fuel via capillary action to the burning zone. To serve as a control, an identical vessel/wick combination containing pure paraffins (NORPAR-15) was also assembled.

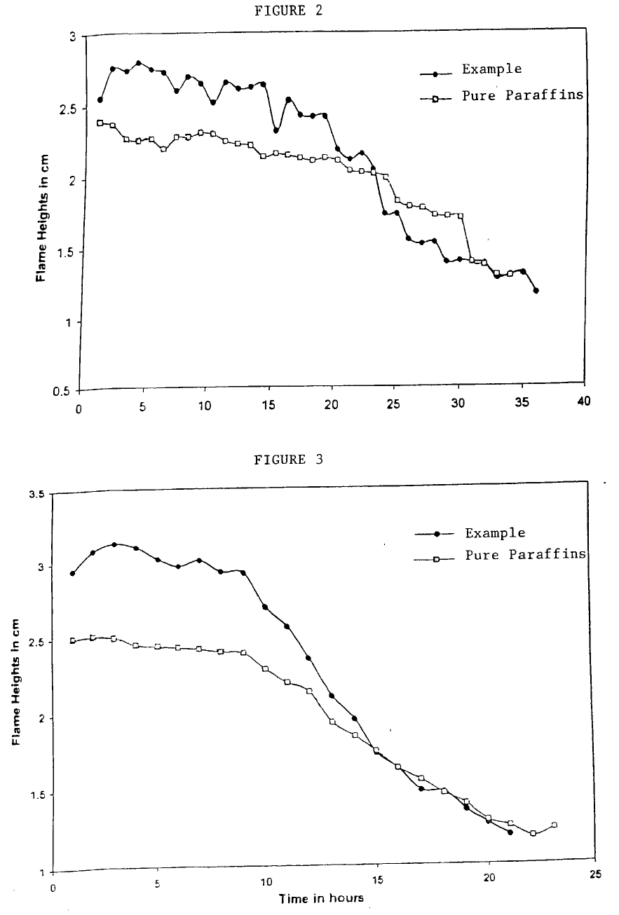

Each fuel was burned, and the flame height was recorded over time, as depicted in FIG. 2. As shown in the figure, the fuel according to the invention burned brighter than the control for over half the life of the liquid candle. The burn rate of the fuel according to the invention was not detrimentally affected by the addition of the alcohols, and in each case was found to be 0.05 g/min.

A parallel test was performed loading the fuel according to the example and the pure paraffins (NORPAR-15) into separate, identical vessels including a cylindrical plastic reservoir measuring 14 cm in height and 3.5 cm in diameter, capped by a 3 cm diameter aluminum cap that sealed the reservoir and provided a burning zone, with a cotton wick (about 3 mm in diameter) disposed in the vessel, partially immersed in the fuel, and exposed to the atmosphere through the cap at the top of the vessel. These liquid candles were burned, and the flame heights were recorded over time, as depicted in FIG. 3. As shown in the figure, the fuel according to the invention burned brighter than the control for nearly ¾ of the life of the liquid candle.

To gauge soot production, in another test an aluminum sheet was placed over a burning liquid candle according to the example and a burning liquid candle containing pure paraffins (NORPAR-15), at 1 inch (2.54 cm) from the base of each flame, for the first ten hours of bum. The fuel of the prior art produced 1.22 grams of soot, whereas the fuel of the invention produced only 0.72 grams of soot. Put another way, the fuel of the invention produced approximately 0.68% soot per gram of fuel, whereas the control produced approximately 1.14% soot per gram of fuel, amounting to a 40% reduction in soot production.

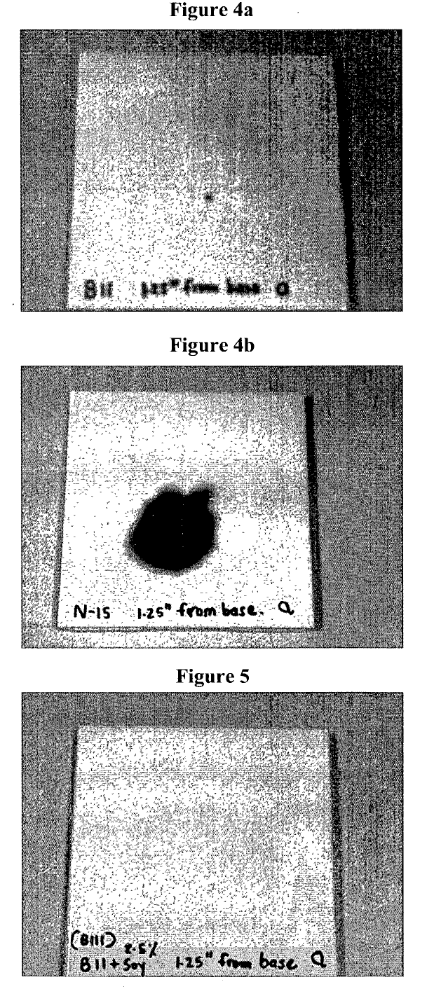

In still another test, a ceramic tile was placed over each burning liquid candle, one loaded with a fuel according to the example and one loaded with pure paraffins (NORPAR-15). The tiles were placed at approximately 1.25 inches (3.18 cm) above the base of each flame to collect soot for 20 minutes. Photos showing the results of the soot collection are shown in FIGS. 4a (example of the invention) and 4b (prior art). The photos clearly show a drastic reduction in visible soot production.

### Example 2

### Liquid Paraffins/Isopropanol/Methanol/Soy Bean Oil Blend

A blend of 95.5 wt. % NORPAR-15 brand liquid paraffins, 1.5 wt. % isopropanol, 0.5 wt. % methanol, and 2.5 wt. % soy bean oil was prepared by blending the alcohols together and then adding the mixture of alcohols and the soy bean oil to the liquid paraffins.

A liquid candle was constructed according to Example 1, and the fuel was burned with a tile placed approximately 1.25 inches (3.18 cm) above the base of the flame to collect soot. A photo showing the results of the soot collection is shown in FIG. 5. Comparison with FIGS. 4a and 4b of Example 1 shows an even further reduction in visible soot production.

The foregoing description is given for clearness of understanding only, and no unnecessary limitations should be understood therefrom, as modifications within the scope of the invention may be apparent to those having ordinary skill in the art.

What is claimed is:

1. A composition useful as a clean-burning candle fuel, comprising:
at least about 30 wt. % of a C₁₅ alkane;
about 1 wt. % to about 25 wt. % isopropanol; and
about 0.5 wt. % to about 10 wt. % methanol.

2. The composition of claim 1, comprising greater than 2 wt. % methanol.

3. The composition of claim 1, comprising about 15 wt. % or less isopropanol.

4. The composition of claim 3, comprising about 1 wt. % isopropanol to about 5 wt. % isopropanol.

5. The composition of claim 1, wherein at least about 50% of the C₁₅ alkane is a normal alkane.

6. The composition of claim 1, further comprising a C₁₄ alkane and a C₁₆ alkane.

7. The composition of claim 6, wherein at least about 50% of all alkanes are normal alkanes.

8. The composition of claim 6, comprising:
about 40 wt. % to about 60 wt. % of a C₁₅ alkane;
about 10 wt. % to about 35 wt. % of a C₁₄ alkane; and
about 1 wt. % to about 20 wt. % of a C₁₆ alkane.

9. The composition of claim 1, further comprising about 0.5 wt. % to about 50 wt. % soybean oil.

10. A composition useful as a clean-burning candle fuel, comprising:
at least about 50 wt. % of at least two hydrocarbon fuels selected from the group consisting of C₁₄-C₁₆ alkanes and mixtures thereof;
about 1 wt. % to about 25 wt. % isopropanol; and
about 0.5 wt. % to about 10 wt. % methanol.

11. The composition of claim 10, comprising greater than 2 wt. % methanol.

12. The composition of claim 10, comprising about 15 wt. % or less isopropanol.

13. The composition of claim 12, comprising about 1 wt. % isopropanol to about 5 wt. % isopropanol.

14. The composition of claim 10, wherein at least about 50% of all alkanes are normal alkanes.

15. The composition of claim 10, further comprising about 0.5 wt. % to about 50 wt. % soybean oil.

16. A composition useful as a clean-burning candle fuel, comprising:
at least about 65 wt. % of a hydrocarbon fuel selected from the group consisting of C₁₂-C₂₂ alkanes and mixtures thereof;
about 1 wt. % to about 25 wt. % isopropanol; and
about 0.5 wt. % to about 10 wt. % methanol;
wherein said fuel produces less than about 1.14% soot when burned, based on the weight of the composition.

17. The composition of claim 16, wherein said fuel produces less than about 0.8% soot when burned, based on the weight of the composition.

18. The composition of claim 16, comprising greater than 2 wt. % methanol.

19. The composition of claim 16, comprising about 15 wt. % or less isopropanol.

20. The composition of claim 18, comprising about 1 wt. % isopropanol to about 5 wt. % isopropanol.

21. The composition of claim 16, wherein at least about 50% of the all alkanes are normal alkanes.

22. The composition of claim 16, comprising a mixture of C₁₄-C₁₈ alkanes.

23. The composition of claim 16, comprising a mixture of C₁₄-C₁₆ alkanes.

24. The composition of claim 16, further comprising about 0.5 wt. % to about 50 wt. % soybean oil.

25. A composition useful as a clean-burning candle fuel, consisting essentially of:
at least about 74.5 wt. % of a hydrocarbon fuel selected from the group consisting of C₁₂-C₂₂ alkanes and mixtures thereof;
about 1 wt. % to about 25 wt. % isopropanol; and
about 0.5 wt. % to about 10 wt. % methanol.

26. A composition useful as a clean-burning candle fuel, comprising:
about 40 wt. % to about 60 wt. % of a C₁₅ alkane;
about 10 wt. % to about 35 wt. % of a C₁₄ alkane;
about 1 wt. % to about 20 wt. % of a C₁₆ alkane;
about 1 wt. % to about 15 wt. % isopropanol; and
about 0.5 wt. % to about 2 wt. % methanol.

27. The composition of claim 26, further comprising about 0.5 wt. % to about 50 wt. % soybean oil.

28. A combination useful as a candle, comprising:
a fuel comprising at least about 65 wt. % of a hydrocarbon fuel selected from the group consisting of C₁₂-C₂₂ alkanes and mixtures thereof, about 1 wt. % to about 25 wt. % isopropanol, and about 0.5 wt. % to about 10 wt. % methanol;
a vessel containing the fuel; and
a candle wick disposed in the vessel and partially immersed in the fuel.

29. The combination of claim 28, wherein the vessel is substantially sealed and is adapted to, in use, allow substantial release of the fuel only through the candle wick.

30. The combination of claim 28, further comprising a shade.
